(19) United States
(12) Patent Application Publication
(10) Pub. No.: US 2020/0370602 A1
(43) Pub. Date: Nov. 26, 2020

(54) Bearing Assembly

(71) Applicants: Ernest George Monserratt, Alhambra, CA (US); Tim Rozema, Ladara Ranch, CA (US); James Hernandez, Anaheim, CA (US)

(72) Inventors: Ernest George Monserratt, Alhambra, CA (US); Tim Rozema, Ladara Ranch, CA (US); James Hernandez, Anaheim, CA (US)

(21) Appl. No.: 16/879,665

(22) Filed: May 20, 2020

Related U.S. Application Data
(60) Provisional application No. 62/850,490, filed on May 20, 2019.

(51) Int. Cl. F16C 33/58; F16C 19/16

(52) U.S. Cl. CPC F16C 33/585; F16C 19/16

(57) ABSTRACT

Bearing assemblies are described herein. For example, a bearing assembly comprising an outer bearing ring, an inner bearing ring, and a ball bearing, wherein the outer bearing ring and inner bearing ring encapsulate the ball bearing. The ball bearing can be fabricated from a polyimide or Superimide SC-610. The outer ring bearing may include a shelf arranged about the perimeter of the inner surface of the outer bearing ring. The bearing assembly can be positioned within a rod end housing, wherein the outer bearing ring is secured in the rod end housing by a swaging operation and the inner bearing ring can be secured in the rod end housing by a swaging operation. The swaging operation can secure the inner bearing ring to the outer bearing ring. The outer bearing ring and inner ring bearing can be integral to the rod end housing.

### CROSS-REFERENCE TO RELATED APPLICATIONS

This application claims priority to pending U.S. Provisional Patent Application Ser. No. 62/650,490, titled “Bearing Assembly,” filed on May 20, 2019, which is expressly incorporated by reference herein in its entirety.

### FIELD OF INVENTION

The present disclosure generally relates to improvements in the design of bearing assemblies. More specifically, the present disclosure relates to manufacturing spherical bearing rod end products and retrofitting existing spherical bearing rod end products with novel bearing assembly designs to provide improved resistance to wear, which results in a higher quality and more reliable spherical bearing rod end product.

### BACKGROUND

For aircraft engines used in the aerospace industry, it is important to design a system (i.e., a collection of various components) that provides for the engine to effectively interface with various other aircraft systems, such as fuel, hydraulic, pneumatic, fire detection, and electrical systems. Such an interfacing system is typically referred to as an engine build-up unit (“EBU”). The EBU typically includes a variety of engine-mounted hardware and components. One type of engine-mounted component is a linkage such as a rod. Such linkages can be used to mechanically link the aircraft engine to the various aircraft systems. Such rods can include an adaptor affixed to the end of the rod that can be mechanically coupled to any number of other engine or aircraft system components. The adaptor can include a spherical bearing that allows for relative movement and rotation between the engine and various aircraft systems. Such adaptors can be referred to as spherical bearing rod ends.

In current EBUs, the wear experienced by such spherical bearing rod ends can lead to frequent maintenance of the spherical bearing rod ends (i.e., inspecting spherical bearing rod ends and replacing spherical bearing rod ends once the performance of the spherical bearing degrades) and even mechanical failure. It will be understood that such frequent maintenance can add cost to operating an aircraft by increasing downtime and the time and effort spent in inspecting and maintaining spherical bearing rod ends. Even more critical, mechanical failure of a spherical bearing can lead to loss of the aircraft and bodily harm or even death for persons on the aircraft.

There is a need to improve the wear resistance of spherical bearing rod ends. The embodiments described and disclosed herein address this need. While the examples provided herein are described in the context of the aerospace industry, it will be understood that the embodiments described and disclosed herein can be applied to many different applications and many different industries.

### SUMMARY

This disclosure describes various embodiments of a bearing assembly, for example a bearing assembly comprising an outer bearing ring, an inner bearing ring, and a ball bearing, wherein the outer bearing ring and inner bearing ring encapsulate the ball bearing. The ball bearing can be fabricated from a polyimide or Superimide SC-610. The outer ring bearing may include a shelf arranged about the perimeter of the inner surface of the outer bearing ring. The bearing assembly can be positioned within a rod end housing, wherein the outer bearing ring is secured in the rod end housing by a swaging operation and the inner bearing ring can be secured in the rod end housing by a swaging operation. The swaging operation can secure the inner bearing ring to the outer bearing ring. The outer bearing ring and inner ring bearing can be integral to the rod end housing. The inner bearing ring and ball bearing can be pre-assembled to the outer bearing ring, where the bearing assembly is secured in the rod end housing by a swaging operation.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates a perspective view of an exemplary linkage with two rod ends, each with a spherical bearing assembly.

FIG. 2 schematically illustrates a perspective view of an exemplary rod end with a spherical bearing assembly.

FIG. 3 schematically illustrates a cross-section view of an exemplary rod end with a spherical bearing assembly.

FIG. 4 schematically illustrates a perspective view of another exemplary rod end with a spherical bearing assembly.

FIG. 5 schematically illustrates an exploded view of the rod end with the spherical bearing assembly of FIG. 4.

FIG. 6 schematically illustrates a cross-sectional view of the rod end with the spherical bearing assembly of FIG. 4.

FIG. 7A schematically illustrates a perspective view of the rod end housing used in the rod end of FIG. 4.

FIG. 7B schematically illustrates a cross-sectional view of the rod end housing used in the rod end of FIG. 4.

FIG. 8 schematically illustrates a perspective view of a partially assembled rod end with the spherical bearing assembly of FIG. 4.

FIG. 9 schematically illustrates a perspective view of a partially assembled rod end with the spherical bearing assembly of FIG. 4.

FIG. 10 schematically illustrates a cross-sectional view of the outer bearing ring and rod end housing of the rod end of FIG. 4.

FIG. 11 schematically illustrates a perspective view of a partially assembled rod end with the spherical bearing assembly of FIG. 4.

FIG. 12 schematically illustrates a perspective view of an assembled rod end with the spherical bearing assembly of FIG. 4.

FIG. 13 schematically illustrates a cross-sectional view of the rod end with the spherical bearing assembly of FIG. 4.

### DETAILED DESCRIPTION

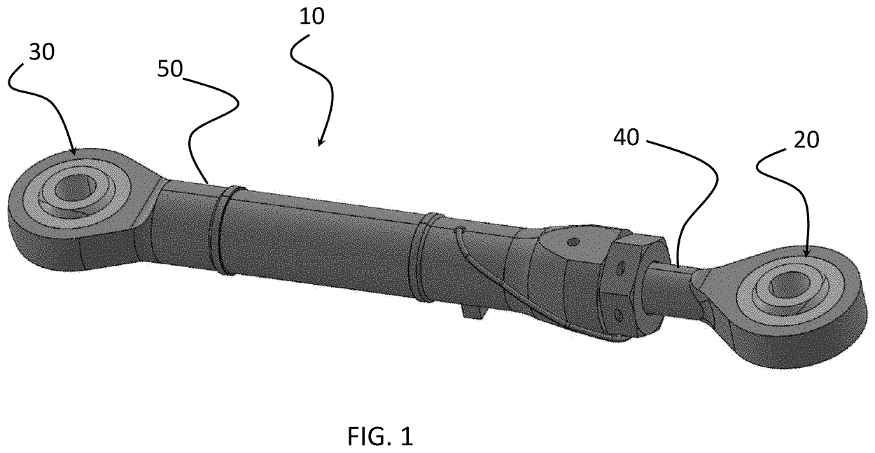

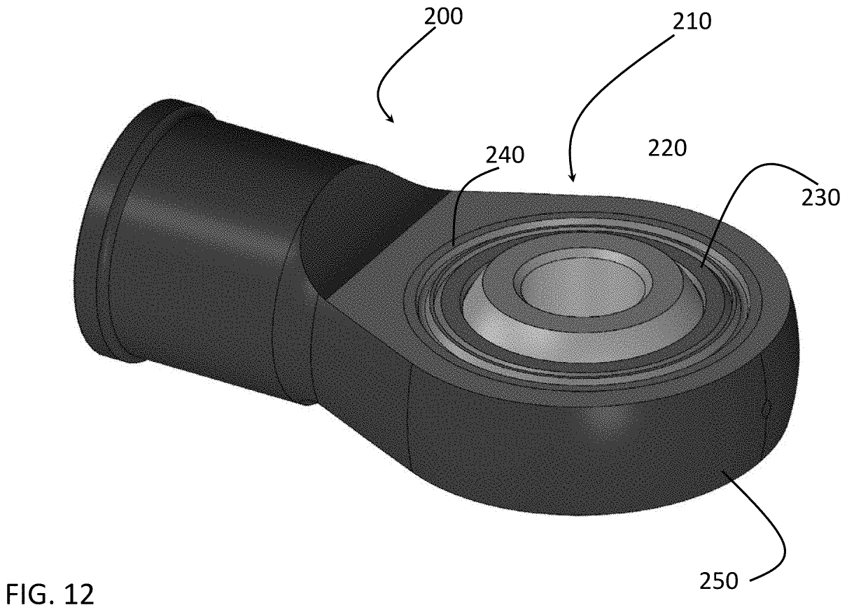

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for spherical bearing rod ends with novel bearing assemblies are hereinafter disclosed and described in detail with reference made to FIGS. 1-13.

Disclosed herein are novel arrangements of spherical bearing rod ends. Specifically, disclosed herein are novel arrangements for spherical bearing assemblies used in spherical bearing rod ends. The novel spherical bearings can be implemented in originally manufactured spherical bearing rod ends or can be installed in existing spherical bearing rod ends during maintenance or retrofitting of such rod ends to improve the performance and service life of the rod ends.

Generally, the spherical bearing assemblies have improved wear resistance as compared to prior art spherical bearings. Such improved wear resistance results in higher quality and more reliable spherical bearing rod ends. Improved wear resistance can be achieved by increasing the bearing area of the ball bearing by containing the ball bearing with a full retainer contact area as compared to prior art loader slot bearing type retainer designs that do not have 360 degree full radial contact. Additionally, improved wear resistance can be achieved by fabricating the ball bearing from materials with superior wear resistant properties. The spherical bearing arrangements disclosed herein provide more efficient manufacturing and assembly methods than for prior art spherical bearings. Additionally, the spherical bearing assemblies disclosed herein do not rely on ball bearings with a particularly high hardness. Therefore, ball bearings can be made of a variety of materials and in many different geometries.

Generally, the spherical bearing assemblies disclosed herein include a ball bearing and a two-piece bearing retainer that provides full bearing support along the inner spherical portion of the bearing retainer. The ball bearing is placed inside a first piece of the bearing retainer and the second piece of the bearing retainer is assembled over the ball bearing and can be held in place by a variety of fastening methods. The material selection for the ball bearing and bearing retainer are chosen to provide increased wear resistance to improve quality and reliability of the spherical bearing assembly.

FIG. 1 illustrates an exemplary embodiment of a linkage 10 with two spherical bearing assemblies 20, 30. The linkage 10 includes a first rod 40 telescopically coupled to a second rod 50 such that the length of the linkage 10 can be adjusted. A first bearing assembly 20 is coupled to the end of the first rod 40, and a second bearing assembly 30 is coupled to the end of the second rod 50. As is described below, when the bearing assemblies 20, 30 are worn and performance begins to deteriorate, the bearing assemblies 20, 30 can be replaced and the linkage 10 retrofitted with new bearings assemblies.

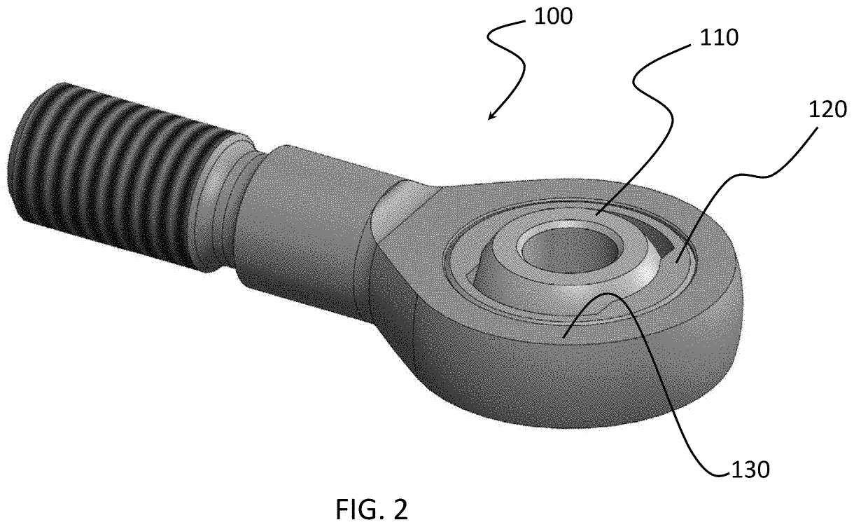

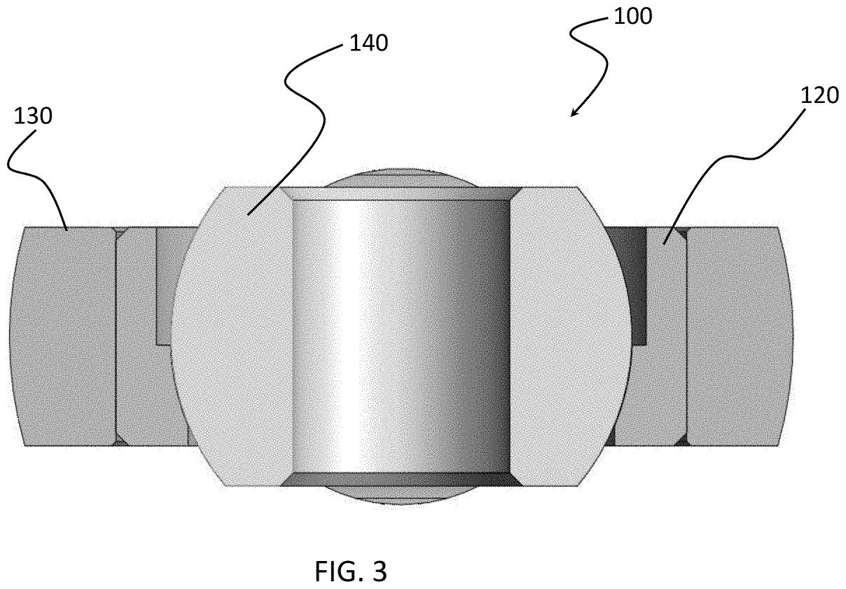

FIGS. 2 and 3 illustrate a method of replacing a worn bearing with a prior art loader slot bearing configuration with a novel spherical ball bearing. FIG. 2 illustrates a spherical bearing rod end 100 with an existing ball bearing 110 and a ring bearing 120, both positioned in a rod end housing 130. Typically, prior art rod ends include a metal ball bearing that is manufactured from an alloy material. In one example, the ball bearing can be manufactured from a cobalt-chromium alloy such as Stellite. When the existing ball bearing 110 is worn, the existing ball bearing 110 can be removed and replaced with a novel ball bearing. Such a novel ball bearing 140 is illustrated in FIG. 3. The novel ball bearing 140 is manufactured from a high temperature polyimide composite material. Once such high temperature polyimide composite material is Superimide SC-610 manufactured by Maverick Molding Company. Superimide SC-610 generally has excellent mechanical properties, including excellent wear resistance, and can operate at high temperatures, which makes the material suitable for aerospace applications. The method for replacing an existing ball bearing 110 with a novel ball bearing 140 begins with the removal of the existing ball bearing 110 from the rod end housing 130, leaving the ring bearing 120 in place. The novel ball bearing 140 is positioned in the ring bearing 120 in a manner to allow the ball bearing to fit through the ring bearing slot and rotated to allow the ball bearing axis to be perpendicular to the rod end housing 130 axis. FIG. 3 is a cross-sectional view of a loader slot spherical bearing rod end with a novel Superimide SC-610 ball bearing 140 in the ring bearing 120.

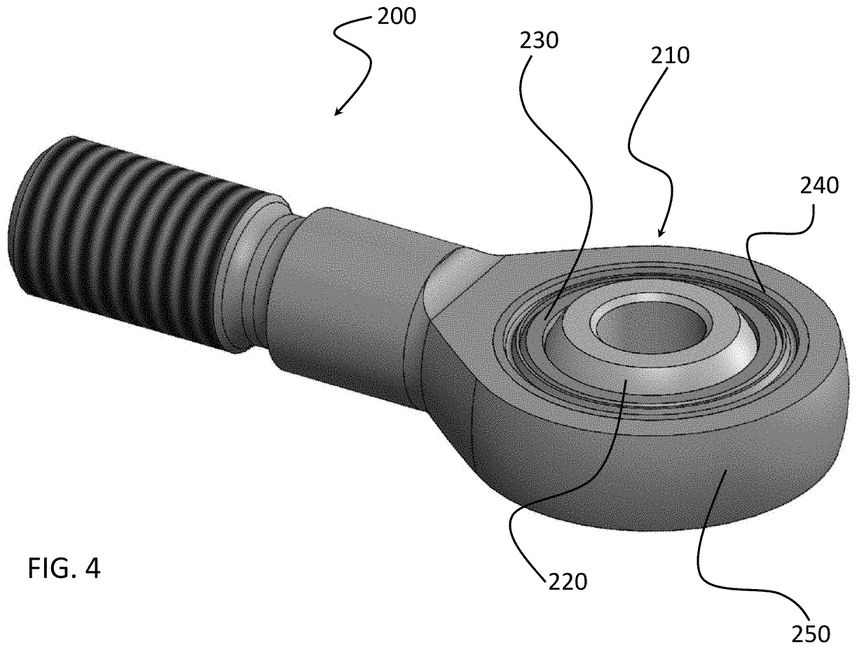

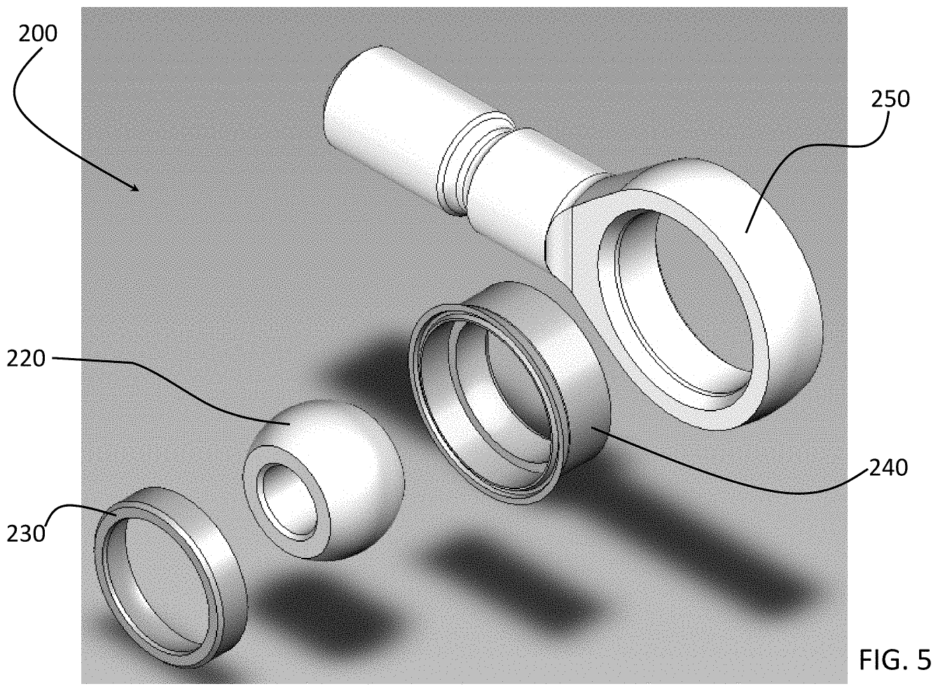

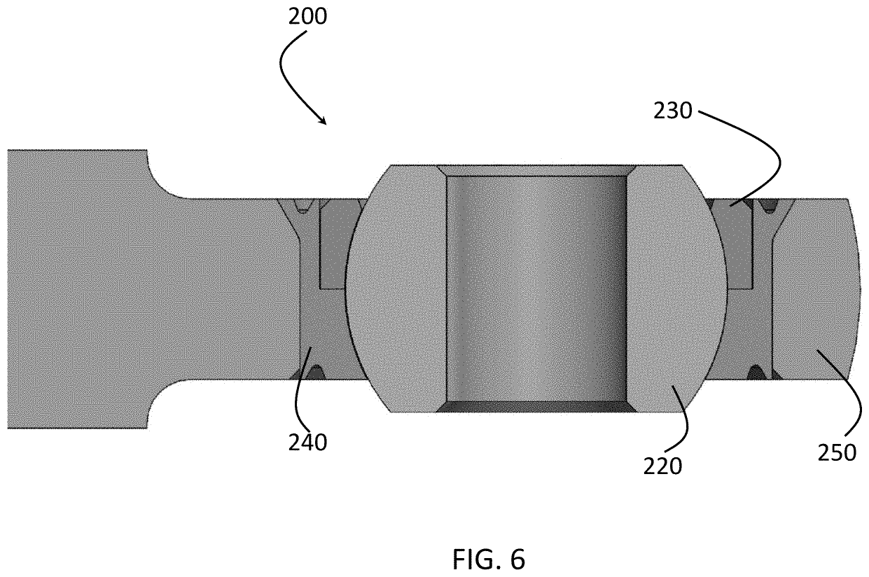

FIGS. 4-13 illustrate a spherical bearing rod end 200 with a novel spherical bearing assembly 210. The spherical bearing assembly 210 can replace a spherical bearing assembly in an existing rod end or can be assembled with a newly manufactured rod end. FIG. 4 illustrates a perspective view of the spherical bearing rod end 200 with the bearing assembly 210, FIG. 5 illustrates an exploded view, and FIG. 6 illustrates a cross-sectional view.

The spherical bearing assembly 210 includes a ball bearing 220 and a two-piece retainer assembly—an inner ring bearing 230 and an outer ring bearing 240—secured in the rod end housing 250. The ball bearing 220 can be manufactured from a high temperature polyimide composite material, such as Superimide SC-610 as previously discussed. The combination of the inner ring bearing 230 and the outer ring bearing 240 are arranged to ensure full contact with the ball bearing 220 when the spherical bearing assembly 210 is fully assembled.

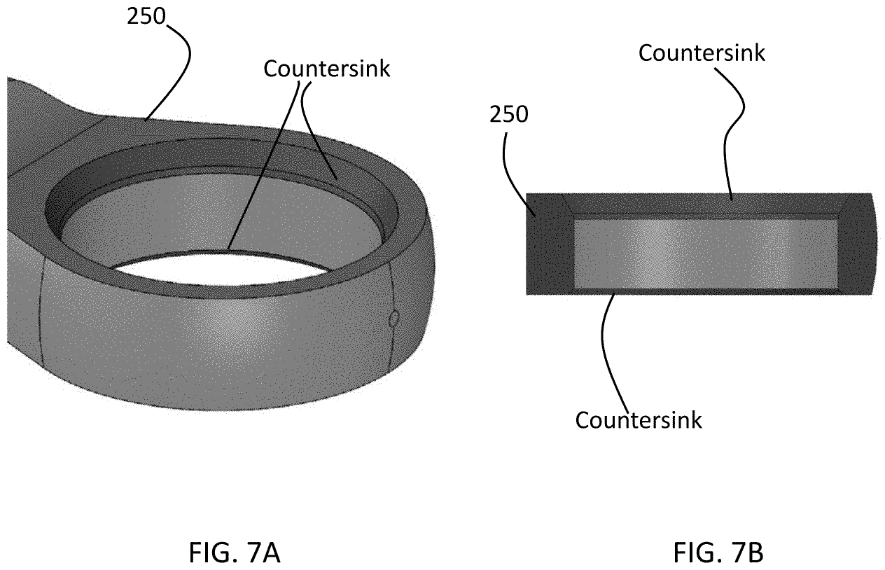

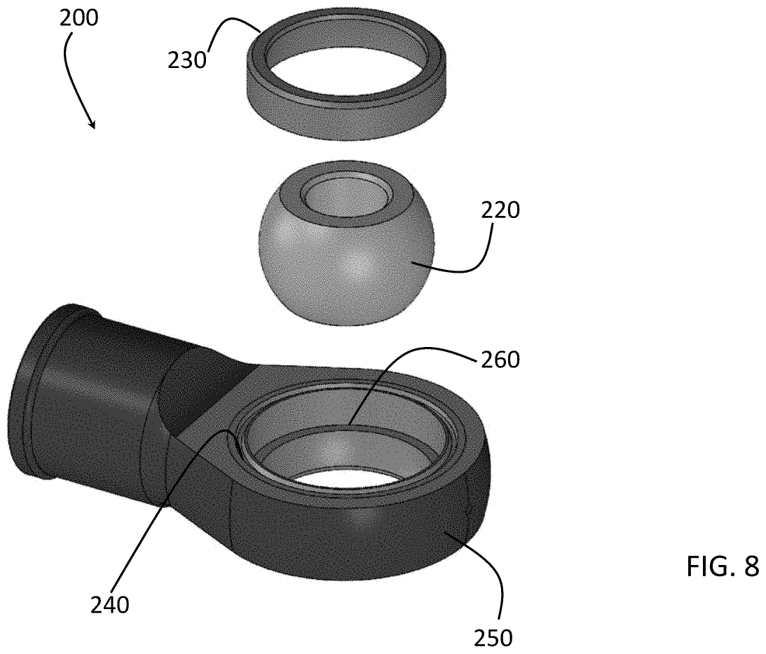

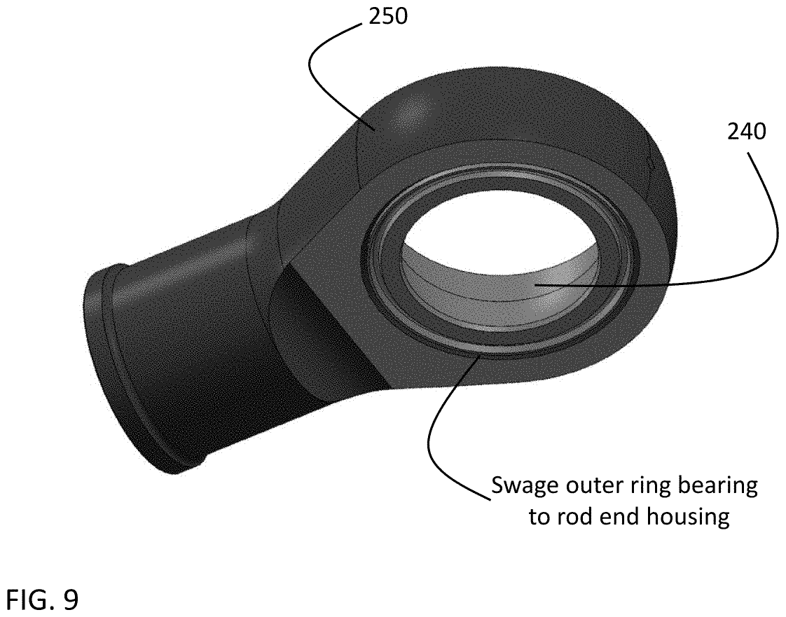

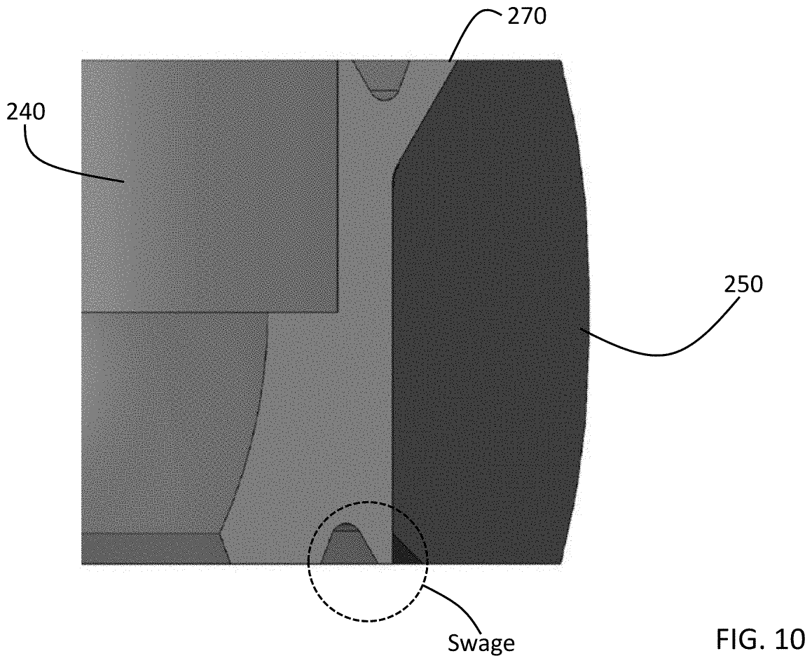

When the spherical bearing assembly 210 is installed in an existing rod end, first the existing bearing is removed along with any ring bearings. The rod end housing 250 is then modified by machining a countersunk edge into the top of the rod end housing 250 and the bottom of the rod end housing 250, see annotations in FIGS. 7A and 7B. Once the rod end housing 250 is machined, the outer ring bearing 240 is inserted into the rod end housing 250, as illustrated in FIG. 8. The outer ring bearing 240 includes a shelf 260 along the perimeter of its inner surface. As will be understood with additional description and disclosure, the shelf 260 engages with the inner ring bearing 230 when the inner ring bearing 230 and outer ring bearing 240 are installed in the rod end housing 250. As annotated in FIGS. 9 and 10, the outer ring bearing 240 can be swaged to the rod end housing 250 at the interface of the outer ring bearing 240 and the bottom edge of the rod end housing 250. As illustrated in FIG. 10, the outer ring bearing 240 includes a flush head feature 270 that facilitate the outer ring bearing 240 resting in the countersunk section at the top of the rod end housing 250.

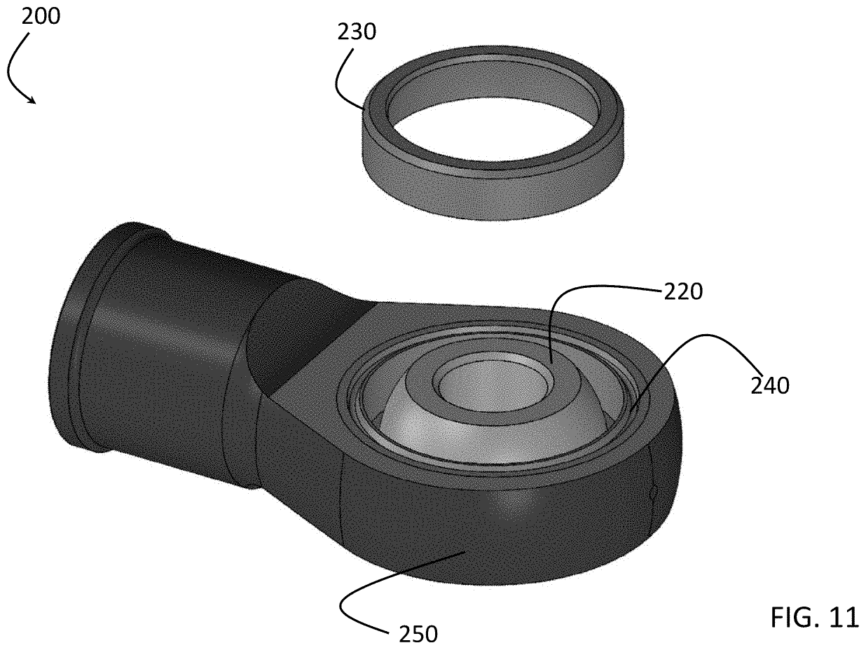

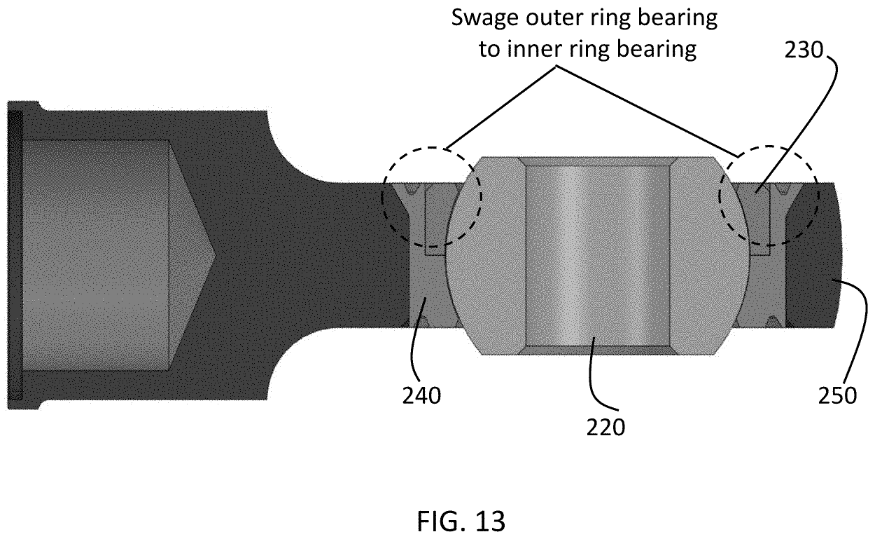

When the outer bearing ring 240 is fully installed in the rod end housing 250, the ball bearing 220 can be installed in the outer ring bearing 240 as illustrated in FIG. 11. Then the inner bearing ring 230 can be installed over the ball bearing 220 and engaged with the shelf 260 of the outer bearing ring 240. To complete the assembly, as annotated in FIG. 13, the inner bearing ring 230 can be swaged by the outer bearing ring 240 along the top side interface of the inner 230 and outer 240 bearing rings.

The inner bearing ring 230 and outer bearing ring 240 can be manufactured from any suitable material, for example, 316 stainless steel or a nickel alloy such as A-286 manufactured to AMS 5732 specifications. The rod end housing 250 can similarly be manufactured from any suitable material, for example, an alloy such as Inconel 625. As previously discussed, in addition to retrofitting an existing rod end with the novel spherical bearing assembly 210, a newly manufactured rod end can be assembled with the spherical bearing assemblies disclosed herein using a substantially similar method as described above.

In another embodiment, similar to the previous embodiment, the bearing assembly can be pre-assembled without the rod end housing and can be later assembled to the rod end housing by swaging the bearing assembly to the rod end housing.

In another embodiment, the width of the rod end can be increased. An increased width will increase the total bearing area between the ball bearing and the inner and outer bearing rings. As will be understood, such an increase in bearing area will more uniformly distribute force, and thus reduce the amount of force at any specific location, along the surface of both the ball bearing and the inner and outer bearing rings. Such an arrangement will decrease the wear on the components of the spherical bearing assembly and increase the service life of the spherical bearing assembly. In yet another embodiment, either the outer bearing ring or the inner bearing ring can be integral to the rod end housing. In such an arrangement, the component that is independent of the rod end housing can be secured to the rod end housing by swaging, welding, or any other such securing mechanism.

The foregoing description of examples have been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A bearing assembly comprising:
an outer bearing ring;
an inner bearing ring; and
a ball bearing;
wherein the outer bearing ring and inner bearing ring encapsulate the ball bearing.

2. The bearing assembly of claim 1, wherein the ball bearing is fabricated from a polyimide.

3. The bearing assembly of claim 2, wherein the ball bearing is fabricated from Superimide SC-610.

4. The bearing assembly of claim 1, wherein the outer ring bearing includes a shelf arranged about the perimeter of the inner surface of the outer bearing ring.

5. The bearing assembly of claim 1, wherein the bearing assembly is positioned within a rod end housing.

6. The bearing assembly of claim 5, wherein the outer bearing ring is secured in the rod end housing by a swaging operation.

7. The bearing assembly of claim 6, wherein the inner bearing ring is secured in the rod end housing by a swaging operation.

8. The bearing assembly of claim 7, wherein the swaging operation secures the inner bearing ring to the outer bearing ring.

9. The bearing assembly of claim 5, wherein the outer bearing ring is integral to the rod end housing.

10. The bearing assembly of claim 5, wherein the inner bearing ring is integral to the rod end housing.

11. The bearing assembly of claim 4, wherein the inner bearing ring and ball bearing are pre-assembled to the outer bearing ring.

12. The bearing assembly of claim 11, wherein the bearing assembly is secured in the rod end housing by a swaging operation.

13. A bearing assembly comprising:
a bearing ring; and
a ball bearing;
wherein the ball bearing is fabricated from a polyimide.

14. The bearing assembly of claim 13, wherein the ball bearing is fabricated from Superimide SC-610.

15. The bearing assembly of claim 13, wherein the bearing assembly is positioned within a rod end housing.

16. The bearing assembly of claim 15, wherein the bearing ring is integral to the rod end housing.
